(19) United States
(12) Patent Application Publication
(10) Pub. No.: US 2016/0137164 A1
(43) Pub. Date: May 19, 2016

(54) INTOXICATED VEHICLE DRIVER ACCIDENT REDUCTION SYSTEM

(71) Applicant: Daniel Jones, Overland Prak, KS (US)

(72) Inventor: Daniel Jones, Overland Prak, KS (US)

(21) Appl. No.: 14/678,619

(22) Filed: Apr. 3, 2015

Related U.S. Application Data
(60) Provisional application No. 62/123,338, filed on Nov. 14, 2014.

(51) Int. Cl. B60R 25/04; F02D 29/02; F02D 35/00; B60W 40/08; F02D 41/22; F02P 11/04; F02N 11/10; F02P 5/15; F02D 17/04; F02D 41/30

(52) U.S. Cl. CPC B60R 25/04; F02D 17/04; F02D 29/02; F02D 35/0007; F02D 41/3005; F02D 41/22; F02P 11/04; F02N 11/101; F02P 5/1502; B60W 40/08; B60W 2040/0836

(57) ABSTRACT

An Apparatus, method and system that blocks vehicle engine starting and reduces engine power when a driver's blood alcohol content is above a pre-set limit. The invention receives an electronic signal from at least one electronically controlled engine sensor and modifies the at least one signal such that the electronically controlled engine is not allowed to start or engine power is reduced, as relating to driver intoxication.

### BACKGROUND OF THE INVENTION

Many thousands of drivers convicted of DUI/DWI have been mandated by Judicial Order to have ignition interrupting or engine starter interrupting systems installed on their vehicles to help ensure after verification of their blood alcohol content (BAC) that they do not operate a vehicle while intoxicated. These systems are generally known as BAIIDs (breath alcohol ignition interlock devises).

The field of ignition interlocks is well known; however, today the majority of these devices simply block electrical power to the starter motor but do not inhibit the ignition system at all. Further, U.S. Pat. No. 3,815,087, “APPARATUS FOR PREVENTING THE DRIVING OF AN AUTOMOBILE OR THE LIKE WHEN THE OPERATOR IS UNDER THE INFLUENCE OF ALCOHOL”, illustrates that as initial systems were developed many decades ago, they typically used a relay, or similar device that could interrupt electrical power to the ignition system. Because of this, even today they are considered Breath Alcohol Ignition Interlock Devices (BAIIDs). The most direct way to stop intoxicated individuals for operating motor vehicles was to prevent the ignition system from providing spark energy to the combustion cylinders. However, diesel engines do not have spark plugs or electronic ignition systems. As more diesel powered passenger vehicles became prevalent, they could not have a spark ignition system blocked as part of the solution to keep intoxicated driver off the road, as they do not contain energized spark plugs. This was one of the reasons that the industry began to only inhibit the starter motor from being provided power to start the engine when an, over the limit, driver BAC was detected.

With improving automotive technology, many ignition systems started to become far more advanced in order to provide more engine power, fuel efficiency and lower emissions. These highly complex ignition systems started including multiple ignition coils, multiple spark patterns, highly varied timing routines and a complex interface with modern Engine Control Systems (ECUs), the engine's main computer. Most vehicles now have computer controlled engines that are integrated with advanced ignition systems. So there is not just one ignition power wire to simply interrupt, as emissions and ECUs can malfunction.

Further, some new vehicles now also employ fully integrated remote start systems at time of factory production into many new models. This complicates the connection between a BAIID engine control box and these highly sophisticated ignition systems.

Another significant problem today is that BAIIDS only stop the engine only from starting. So in the event that the driver is just below the threshold limits at engine start up, then they are fully able to drive in an unconstrained manner if they continue to ingest alcohol. Once the engine is started, the starting system cannot limit or reduce the danger of an intoxicated driver operating a motor vehicle.

Another significant problem is that currently available BAIIDs only prevent the engine from starting. So the BAIID could measure a BAC just below the threshold limit and allow engine starting, but previously consumed alcohol may continue to enter the driver blood stream, thereby increasing intoxication while driving. Additionally, the driver may have passed a BAC measurement prior to starting the engine, but may consume alcohol and drive the vehicle. The systems on the market today are required, by law, to re-test periodically but no action is taken to incrementally or systematically reduce engine power or slow the vehicle; just to record the illegal event. Accordingly, the intoxicated driver is allowed to continue driving on the public roads and highways.

It is commonly known that speed kills and with more speed, the more adverse the consequences can and may be, especially when a driver is intoxicated. An impaired Driver is more likely to compound the severity of an accident than a sober driver. An impaired driver generally has far less ability to take at least some corrective actions so as to mitigate the impact energy, direction of travel and likelihood of evolving more vehicles and pedestrians in a collision.

Additionally, if an intoxicated individual fails a re-test in a BAIID equipped vehicle, they may be less likely to properly process the punitive consequences of continuing to drive. Due to the nature of these drivers' ability to reason, every day hundreds of intoxicated drivers continue to drive even with failed re-tests.

Convicted Drivers who are willing to ignore a failed re-test, may be more likely to become repeat offenders. As such, intoxicated drivers may not have the state of mind to prioritize much more than their immediate circumstances, and are more likely to ignore other related laws and regulation.

More importantly, a group of convicted drivers that are failing or willfully refusing a re-test are generally more likely to have been convicted of DUI/DWI several times. As a convicted driver, and again disregarding the law, there is a much stronger incentive for them to actually speed up so as to more quickly get to their destination and avoid getting caught in the act.

Accordingly with increased speed combined with intoxication, the nature and impact to the public safety is exponentially compounded. Convicted drivers that are again intoxicated and risking significant fines and imprisonment, could be some of the most dangerous and lethal drivers on the road.

The advent and technological advancements of BAIIDs over the last number of years has inarguably helped to incentivized tens of thousands of drivers to stop driving while intoxicated. But without the ability to do more than just warn these drivers through electronic means, more lives are at great risk of death and severe injury.

In addition, there have been a number of attempts, some cited by the inventor, to incorporate BAIIDs in commutation with speed limiting and engine power reduction functions. However, these systems have been too costly, complex, or even have required monitored call control centers staffed with personnel to assist with every driver that has not fully complied with measured BAC levels. Accordingly they are not commercialized and available to assist in the public interest.

The prior art in this field however does disclose considerable quantities of highly detailed apparatus and methodology concerning the enablement of the determination of driver BAC levels and highly detailed and critically important event recording systems. These significantly advanced and evolved BAC measuring, monitoring and recording systems allow specially trained and certified staff and monitoring installation centers to closely track attempts made by drivers required to use a BAIID. However, there are very minimal and sometimes no enablement specifications described in prior art systems that suggest an attempt to actually control engine functionality as a cost effective bolt on system.

In U.S. Pat. No. 8,686,864, “APPARATUS, SYSTEM, AND METHOD FOR DETECTING THE PRESENCE OF AN INTOXICATED DRIVER AND CONTROLLING THE OPERATION OF A VEHICLE”. Hannon discloses a complex system that in addition to monitoring BAC, also suggests the ability to control the operation of a vehicle. Hannon merely cites a “Control Module can disable critical vehicle systems such as a fuel system, transmission system, or ignition system to prevent operation of the vehicle by an intoxicated driver”. Hannon fails to disclose how the “control module” operates. Sofer in U.S. Pat. No. 7,671,752, “CAR ALCOHOL MONITORING SYSTEM”, discloses “A Speed controller is provided for setting the maximum speed of the car to a pre-determined level in the event that the amount of alcohol detected in the driver is above a predetermined threshold”, but fails to describe how this action is actually enabled or achieved. Further, Sofer simplistically suggests that the invention “is coupled to the car's fuel injection system” and again fails to provide enablement. In another embodiment, Sofer states that the “invention, may be coupled to the air valve unit within the throttle system”. And in another embodiment, Sofer suggests that the use of a “gear lock mechanism that is configured to set the car's gears to a predetermined low level when there is an indication that the driver is intoxicated”, but does not provide details or means in order to do so.

Many other prior art references simply suggest “some” connection with the vehicle's air intake system, fuel system, or ECM's service port. Some prior art provides limited detail of operational function concerning the air intake or fuel systems, but most have just considered connecting to a significant and complex vehicle air induction, fuel or computerized control system without regard to the nature of these system's critically complex and uniquely formatted flow capacities and geometries as they relate to the many dozens of different vehicle engine families and in cooperation with dozens of unique vehicle manufacturers worldwide.

The field of this invention is for BAIIDs that are installed on a wide variety of vehicles and as an aftermarket accessory and generally on a temporary basis. They are installed for a term of months to several years, as determined by judicial order. At the time in which this term ends, they are removed and may be installed on another vehicle for the same purpose. The prior art simply does not allow compliance staff and facilities to affordably and quickly install aftermarket installations of BAIIDs and then allow their easy removal and with no damage or harm to the vehicle, its engine, drive train, or emissions systems.

### SUMMARY OF THE INVENTION

What is needed is an improved BAIID that can be easily installed as aftermarket equipment and then be easily removed, which can prevent engine starting and also reduce engine power.

An Improved BAIID that will block a spark ignited or compression ignited diesel engines from starting if a driver does not pass the BAC pre-set threshold. An improved BAIID not only reliant on interrupting power to the starter motor, as vehicles can be push started.

An Improved BAIID that will block gas, spark ignited engines from starting that is not reliant on interrupting the engine's ignition system directly by blocking current to it. This, as ignition systems now may require multiple connections, and may also contain remote start features.

An improved BAND that has the ability to control various engine power parameters as driver intoxication is detected in a re-test, and based on pre-determined thresholds of power reduction, that will promote far greater levels of public safety.

An improved BAIID that does not require the removal, modification, or manipulation of the vehicle air intake system, and the need for a compliance facility to inventory many dozens of air intake systems, hardware and highly specialized components.

An improved BAIID that does not require a complex and costly aftermarket secondary air throttling system requiring a computerized actuator motor, an integrated valving system, and an integrated electronic control system for this purpose.

An improved BAIID that does not require the disconnection, modification or manipulation of a high pressure automotive fuel system, and the need for a compliance facility to inventory many dozens of fuel valving systems, hardware and highly specialized components.

An improved BAIID that does not require a complex and costly aftermarket fuel throttling system requiring a computerized actuator motor and integrated electronic control system to reduce fuel supply directly.

An improved BAIID that does not require the removal of a vehicle transmission and costly components and intensive labor to install and uninstall these highly specialized components, and that does not require a compliance facility to inventory hardware and highly specialized equipment and components for many dozens of vehicle platforms.

My invention consists of a new and novel engine management control system in combination with a BAIID is used to limit or change the operating power output of any engine that is equipped with OEM engine sensors, and those specific to emissions controlled spark ignited or diesel engines, which are on the vast majority of vehicles on the US roads today.

Referenced attempts and others prior art that throttles or governs power output of an internal combustion engine have suggested additional intake air throttle systems, inline fuel restriction valving systems, and electronic voltage or signal control to fuel pumps, so as to reduce fuel when commanded and resulting engine power.

However these, as would be incorporated into a BAIID, would require elaborate in complex air intake systems and/or very precision fuel interface variable restriction systems and equipment which would add significant cost and significant time to install on any of the thousands of vehicles that are required to have a BAIID installed, so as to restrict their driving privileges. Simply limiting fuel supply alone provides a lean combustion air fuel ratio and can and may cause significant engine damage.

My invention instead uses an “engine control processor”, hereto referenced as an “ECP” unit. This inventive microprocessor control unit contains wiring provisions specific to each vehicle engine platform, and that vary by year, make, and manufacturer.

This ECP is constructed and programmed specifically for each engine platform, so that all desired engine power and RPM reductions are produced by the input values of any of a number of engine sensors, alone or in combination, and calculating the appropriate modified electronic outputs so as to achieve the desired engine performance and characteristics.

Contained within each and every emissions equipped and controlled vehicle that is legally sold in the US and which complies with EPA, C.A.R.B. California and Federal emissions standards are many very needed and unique electronic sensors and meters. These sensors and meters help the engine computer (ECU) make decisions thousands of times a second. So the ECU is integrally involved each and every time any emissions controlled vehicle, either spark ignited or compression ignited, is started or operated, and 100% of the time the engine is running.

However, what was not known is that with my new and unique methods of manipulation and changes to these signal outputs of these certain engine sensors, is that my novel ECP, modifies sensor signals with complex and unique methods so the function and power of the engine can be controlled with a high degree of precision without affecting engine reliability. And no matter to what degree the intoxicated driver attempts to gain greater speed by opening the throttle pedal, these highly synchronized sensor signal manipulations communicate the appropriate series of coordinated input signals to the engine's ECU, so as to reduce power and RPM in accordance with pre-determined parameters and guidelines.

This degree of precision is in many ways similar to that of standard and known engine controls such as intake air throttles, and ignition switches to turn on or off an engine, however my invention requires no physical hardware which actually restricts intake air, fuel supply, or changes or changes the transmission gear ratio.

My invention simply connects to existing sensors, and therefore is “plug and play”. By unplugging an existing engine sensor, and plugging in an input wire harness from the ECP, my ECP contains an identical wire harness that directly plugs into the factory equipped wire harness that originally plugged into a particular sensor as above. Multiple sensors can be employed for advanced function, or dependent on particular engine family and its factory operating system, in some cases one sensor can provided the needed blocking of engine starting and power reduction after start up.

The scope of my invention may or may not include the use of the following sensors, but is not limited to the use of additional or other sensors not listed or included in the following;

### Mass Air Sensor

Crankshaft position sensor
Camshaft position sensor
Throttle position sensor
Manifold pressure sensor
Air intake temperature sensor
Ambient air temperature sensor
Coolant sensor
Engine oil temperature sensor

My invention continuously monitors sensor output when an engine is started or running by reading the electronic output data supplied by the Mass Air Sensor, and/or the Crankshaft or Camshaft sensors, or other sensors. Crankshaft position sensors are equipped on all emissions controlled and even most non-emissions controlled electronic fuel injected vehicles; this includes spark ignited or compression ignited internal combustion engines.

The ECP is continually reading the engine RPM of the engine even if just a “speed density” system, not the more modern Mass Air Sensor fuel injection systems. The ECP can utilize either several of these sensors in combination or separately and in addition can substitute a camshaft position sensor as opposed to a crankshaft position sensor to determine engine RPM at all times.

A preferred first step of operation for the ECP is to determine engine speed, and this also determines if the engine is running at all. Reading engine speed from the output signal of a Crank or Cam Position sensor provides the ECP real time engine RPM. And in combination, reading the MAP sensor output signals correlates directly to approximated engine Horsepower. So in the case that these sensors are used in combination, engine starting can be accomplished by interrupting any speed sensor (CPS) and a lower mass air signal sent to the vehicle's ECU, with cause it to command significantly less fuel to the engine, and reduce engine Horsepower.

To inhibit engine starting, in some cases, any of the 3 above sensors can be used depending on engine ECU programming logic. However, other vehicle platforms may be used alone as a single signal from one individual sensor and can provide effective enough manipulated data from the ECP to the ECU that most engines will not be startable.

When there is the desire and need to restrict power and RPM to preset values, these same, as listed above, sensors can be employed alone or in combination, or more precise control of engine power and speed.

These are some of the general parameters of engine operation that my invention controls;

Inhibit the engine from starting at all. This, most likely in cases when the environmental temperature conditions are not a threat to the driver or vehicle occupants.

Allow the engine to start and idle, but if more power is commanded by an intoxicated driver, so as to drive the vehicle, the ECP can be programmed to shut off the engine before the vehicle is accelerated, or simply limit the engine RPM to idle only.

While driving, if a driver should fail a re-test the ECP can control the engine power and speed in numerous capacities. Such as not to allow the intoxicated driver full and obstructed access to full engine power and acceleration, and to limit speed to just below posted highway maximums for any given jurisdiction.

While driving, if a driver should fail a re-test the ECP can control the engine power and speed in numerous capacities. Such that several sudden and unexpected, hard and momentary losses of power override the stereo or any other distractions that one, especially when intoxicated can be more easily be distracted. These warnings that consist of very momentary and abrupt power losses will send a powerful message to the offending driver. The message that they are no longer in full control of the vehicle, and that the consequence of prosecution and legal penalties should be strongly considered. With this feature, the communication to the Driver is being physically reinforced by the vehicle itself and in real time. This is far more compelling than just visible or verbal warning.

While driving, if a driver should fail a re-test the ECP can control the engine power and speed in numerous capacities. Another aspect of the invention is that the reduction of power and speed may be indexed to BAC above 0.02 and use a sliding scale. So if a driver's BAC is increasing while driving, or failing to take the re-test at all, the vehicle will continue to slow and lose power at a reasoned and predetermined pace. This so as not to cause addition risk or loss of safety to the driver or other

### BRIEF DESCRIPTION OF THE DRAWINGS

FIG. 1 illustrates a Vehicle with a single driver, and a BAC measurement device, including an internal combustion engine outfitted with several engine management sensors, an ECP (Engine Control Processor) and an ECU (Engine Control Unit).

FIG. 2 illustrates and internal combustion engine outfitted with several engine management sensors that are in communication with an ECP.

FIG. 3 illustrates a rear view of an internal combustion engine with a CPS (Crankshaft Position Sensor) that is located adjacent to the Flywheel.

FIG. 4 illustrates a one embodiment of a top view of and EPC processor unit.

FIG. 5 illustrates an open side view of a MAF (Mass Air Sensor), as is currently standard equipment on most passenger vehicles and light trucks.

FIG. 6 illustrates an open view of a CPS (Crankshaft Position Sensor), as is currently standard equipment on most passenger vehicles and light trucks.

FIG. 7 is a flow diagram of the interconnection of several standard vehicle engine sensors, the EPC and the ECU.

FIG. 8 is a line chart of Engine Intake Air in CFM to Engine RPM of a typical 300 Horsepower gasoline internal spark combustion engine.

FIG. 9 is a representative characteristic chart graph of a typical 3500 Pound vehicle with relation to Horsepower and correlation to its potential top speed.

FIG. 10 is a representative characteristic chart graph of a typical spark ignited internal combustion engine, illustrating relation to required spark advance or retard at WOT (wide open throttle) so as to avoid auto ignition and/or pre-ignition.

### DETAILED DESCRIPTION OF THE INVENTION

When describing the current invention, all terms not defined herein have their common art recognized meanings. To the extent that the following description is of a specific embodiment or a particular use of the invention, it is intended to be illustrative only, and not limiting of the claimed invention. The following description is intended to cover all alternatives and equivalents that are included in the scope of the invention, as defined in the claims.

It should be generally understood that a significant amount of the subject matter of my invention relates to an “after-market” engine power reduction and starting blocking system in communication with any BAC measurement device. Alternatively there are, and it may be found in cases that some aspects and attributes of this invention are capable of being fully integrated as original factory installed vehicle equipment, parts and system methods.

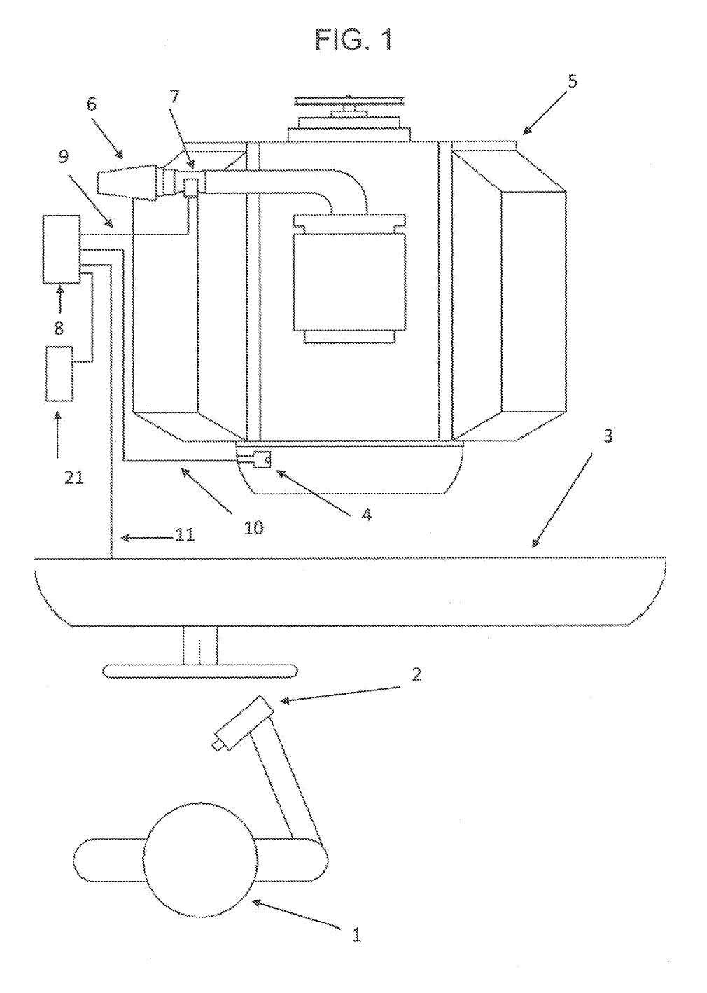

Driver intoxication and vehicle engine starting inhibiting and power reduction system is depicted in FIG. 1. Driver 1 has been compelled to breathe into BAC (blood alcohol content) 2 measurement device that is in communication (not shown) with ECP (engine control processor) 8, though wiring harness 11. In one embodiment ECP 8 receives electronic signals from CPS (crankshaft position center) 4 and MAF (mass airflow center) 7 through one harnesses 9 and 10. Electronic signals are received by ECP 8, and the signals are conditioned, modified, interrupted or otherwise changed and sent to ECU (engine control unit) 21. Also depicted in FIG. 1 is internal combustion engine 5, firewall 3 and air filter 6.

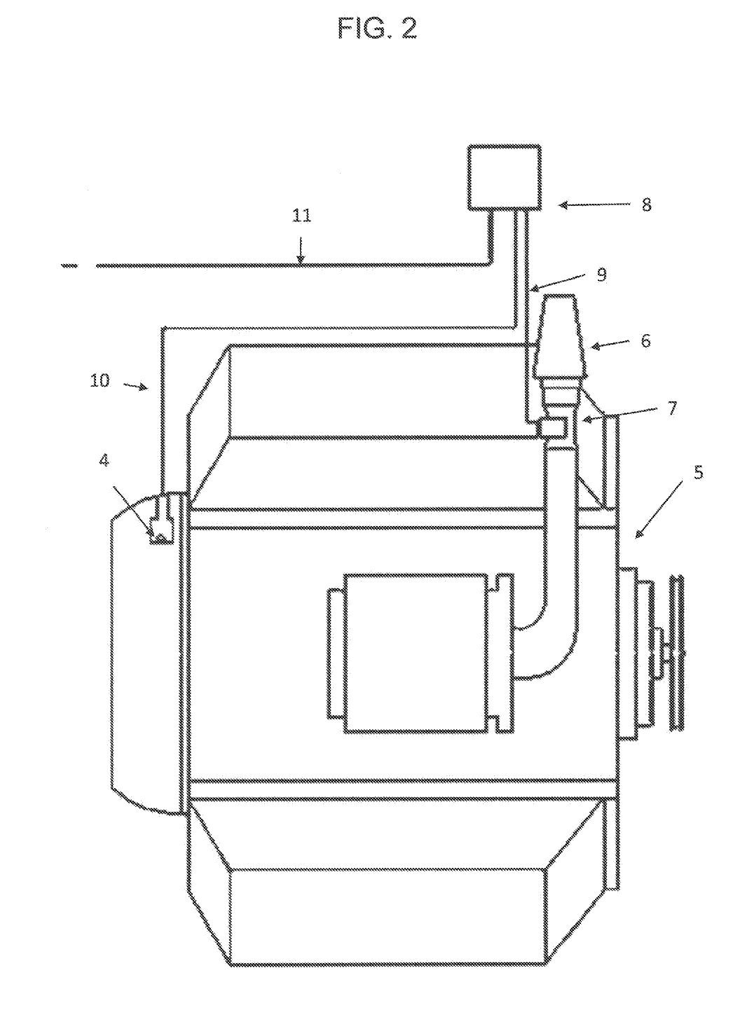

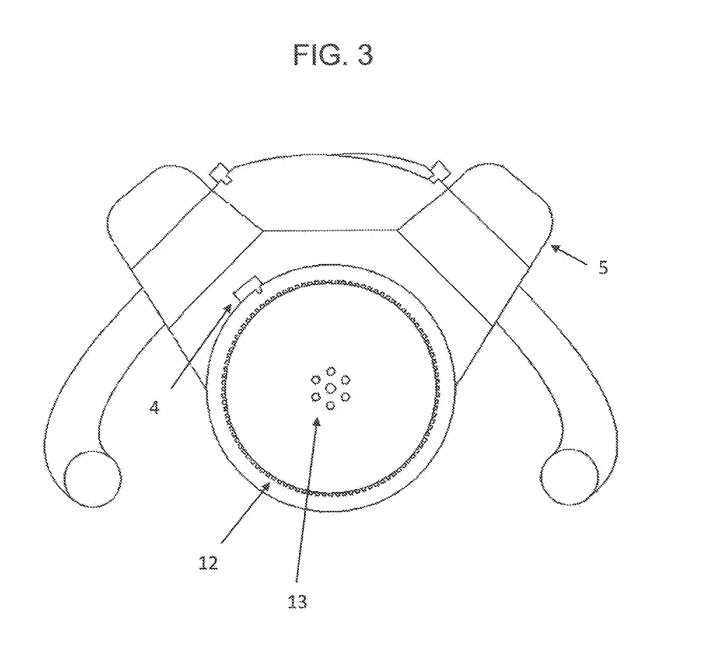

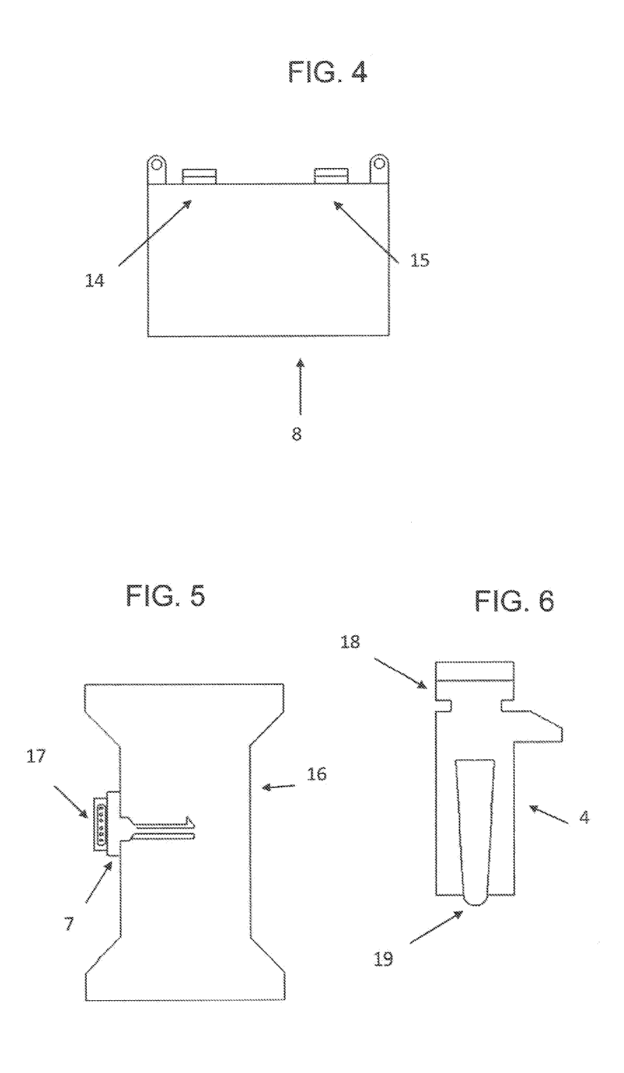

FIG. 2 is a larger scale view of internal combustion engine 5 and related components as shown in a preferred embodiment of the invention. FIG. 3 additionally depicts flywheel 12 and crankshaft fasteners 13. Both of which are not shown in FIG. 1. FIG. 4 illustrates the ECP 8 and electronic input connection 14, and electronic output connection 15. Not shown is a provision for connecting wiring harness 11, as harness 11 is integrated into ECP 8.

FIG. 5 illustrates MAF 7 as is commonly integrated and installed into tubular housing for receiving engine intake air and passing all of this engine intake mass air through mass air sensor assembly 16. FIG. 5 also illustrates electronic input and output connection 17. FIG. 6 illustrates a common crankshaft position sensor 4, which contains an electronic input and output connection 18, and inductive magnet 19. Other substitute sensors for determining engine rotation are not shown, but are also used in some engine configurations, as camshaft positions sensors and others.

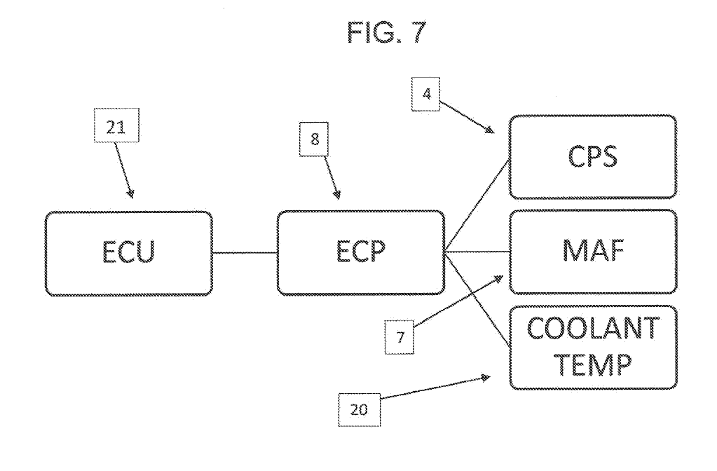

FIG. 7 is a flow diagram that includes engine coolant temperature sensor 20 in accordance with one embodiment of the invention. Engine coolant temperature sensor 20, as with numerous additional sensors that are not shown, can be used in additional embodiments in order to provide more precise or specific functionality in the event that certain engine families respond more effectively. This, concerning engine controllability as relates to this invention.

In another embodiment, CPS 4 is used exclusively to control engine starting and power reduction. When unacceptable driver intoxication levels are detected by BAC 2 monitoring device, they may be deemed unacceptable due to the fact that a BAC (blood alcohol content) of over 0.02 has been detected. Contrary to the fact that many jurisdictions may not consider a BAC of 0.02 unacceptable for a convicted driver to be allowed to start the vehicle's engine, many do find a 0.02 BAC content unacceptable.

Accordingly, as an aspect of this embodiment, only the electronic output signal from CPS 4 is required to be processed by ECP 8 in order to disallow the engine to start in the event that an appropriate jurisdiction's acceptable legal BAC threshold has been breached. When an electronic command signal is delivered through wiring harness 11 to ECP 8 requiring that engine starting should be disallowed, ECP 8 does not allow electronic output signals from CPS 4 to be passed through to ECU 21. Accordingly, ECU 21 does not recognize any internal combustion engine 5 crankshaft rotations, and therefore does not provide any ignition energy to spark plugs that are equipped in spark ignited engines, or does ECU 21 allow any fuel to either spark ignited or combustion ignited engines. Through this process, no CPS 4 equipped internal combustion engines will start or operate when commanded as within the scope of this invention.

Further, in the event that the BAC has not exceeded the jurisdictional limits, and the internal combustion engine is allowed to start and driver 1 is driving or operating the vehicle, but however either fails to comply with a required retest of BAC, or when retested, fails to indicate legal sobriety, using only CPS 4, ECU 21 can be exclusively used to limit power of internal combustion engine 5 in many cases.

Several inventive processes employ rapid intermittent interruptions of electronic signal pulses, changes of voltage, or changes to resistance of electronic signal, of various types of CPS 4 electronic output signals that are generated by various CPS manufacturers. Most CPS units are inductive pickup via a magnet, that produce a signal of various types to the ECU 21 in correlation with engine RPM. As internal combustion engine 5 power reductions are commanded by pre-set determination and programming, the signal value that correlates to any engine RPM sensor is modified such that ECU 21 receives from ECP 8 missing signal patterns that are a fractional quotient of the full and uninterrupted signal from CPS 4. This inventive process such that a significant portion of the ignition events are cancelled and also in many ECU's, fuel injector events are cancelled, reducing fuel to the engine.

An ECU 21 is an internal combustion engine's brain or computer processor, and in order for mandated emissions compliance, all ECU's are programmed to read numerous sensors, most of which are not relied on as inputs for this invention. ECU 21 must sync all input signals with proper pre-programmed look up tables, algorithms and acceptable engine parameters such that correct outputs are generated to the engine for proper engine operation. However, the inventive aspect of generating a partial pulse values as interpreted by ECU 21, such that it reduces fuel and spark frequency to a spark ignited internal combustion engine 5 is unique to the field of BAIIDS. Further, with differing electronic pulse values generated by ECP 8, combustion ignited engines also significantly reduce power output because less fuel is delivered, and in spite of the lack of any ignition system integrated into these types of engines (Diesel), the opportunity for pre-ignition is not present as they are configured, and by design, as they already pre-ignite continuously during proper combustion and operation.

Accordingly, when a significant quantity of fuel is removed in compression ignited engines, power output is reduced dramatically and exhaust valve and exiting gas temperatures are generally reduced. Diesel engines utilizing my inventive method of removing power through the intercepting of the output signal of the CPS 4 or substitute sensor (not shown), reduce engine power proportionally with the intensity of the interrupted rotating electronic signatures as perceived by ECU 21. So when drivers have failed a required retest or have been measured by BAC 2 or any like kind driver blood alcohol measurement systems to be over the threshold blood alcohol content, engine power can be controlled, limited, reduced or safely shut off completely when desired.

FIG. 10 is a line graph that illustrates a typical emission equipped and compliant spark ignited engine in relation to reduction of the ratio of the quantity of combustion fuel to the quantity of combustion air, or commonly referred to as the “air fuel ratio”, so as to avoid pre-ignition at various air fuel ratios. All FIG. 10 line graph plotted values are at W.O.T. (wide open throttle). This as convicted drivers that have failed a BAC 2 retest or have failed to take a retest, may likely be motivated to try to overcome the power reduction that this invention is producing by pushing the accelerator pedal (not shown) much further open, or to the floor, therefore fully opening the engine intake throttle. This allows the full quantity of intake air to enter the engine, but with the significant reduction of fuel to the engine as outlined above. Therefore, the air fuel ratio in the combustion chamber becomes increasingly lean and the propensity for auto ignition (detonation or pre-ignition) becomes far greater as fuel quantity is reduced but air quantity is unchanged or increased.

It is commonly known that meaningful pre-ignition or detonation can and will typically produce significant engine damage and in many cases, complete engine destruction. In spark ignited internal combustion engines, when “auto ignition” occurs before scheduled ignition in the cylinder, and in addition to the possibility of engine failure, significant oxides of nitrogen (NOX) are produced by this improper combustion process and emitted out the tailpipe as harmful emission discharge.

The left side of line graph depicted in FIG. 10 illustrates that when the air fuel ratio is contains more fuel by weight than air by weight, the ratio is referred as “richer” than stoichiometric and the engine will tolerate significant ignition timing advance and make more horsepower. However, when A/F ratios are “leaner” than stoichiometric, significant retarding of ignition timing must be utilized so that engine damaging pre-ignition, detonation and non-complying EPA designated emission levels are not produced.

In the preceding aspect of the invention, only one rotating sensor is required to have its electronic output signal manipulated such that it is not passed through to ECU 21, and therefore engine 5 will not start. In addition, the power of the engine can also be significantly reduced at will, by rapidly interrupting, eliminating some pulses, reducing voltage, changing resistance or other specific sensor outputs that lead ECU 21 reduce fuel supply and power. And in accordance with the scope of the invention, in spark ignited engines, minimal power reduction may be sufficient to a particular jurisdiction's needs, as applied to reducing vehicle speed and public safety. Accordingly, with the monitoring of the air fuel ratio by the exhaust oxygen sensors, many ECU's may have adequate offset range as programmed so as to maintain a safe air fuel ratio and avoid pre-ignition, detonation and harmful emissions.

An additional aspect of the invention that also uses one rotational engine sensor and no other sensors to reduce power, is the combination of ignition timing retard alone, or simultaneously and in conjunction with interrupted or modified electronic CPS 4 sensor output signals that determine engine rotation and RPM, or substitute sensors. This inventive aspect momentarily retards or reduces ECU 21 commanded ignition timing, with momentary and repeated reductions of timing, and rapid restorations. These fluctuating ignition retarding cycles, are applied for a fraction of a second and up to several seconds, based on dynamic operation of varying engine families and their specific operating characteristics.

If ignition timing of its spark ignited internal combustion engine is significantly reduced, engine output power is also reduced. However, if fuel delivery quantity is not reduced by a significant manner, the air fuel ratio becomes excessively rich, misfiring in the combustion cylinders may occur, and within a short time period, unburned fuel will dilute the lubricating oil film from the cylinder walls causing significant piston ring friction and wear to the engine.

However, as provided by this invention, it has been discovered that when ignition timing is momentarily retarded and restored before misfire occurs, then the exhaust gas temperatures are limited to a reliable threshold and lubrication of the piston rings are maintained. Therefore, the net effective vehicle's engine power output is significantly reduced, and accordingly vehicle speed is significantly limited.

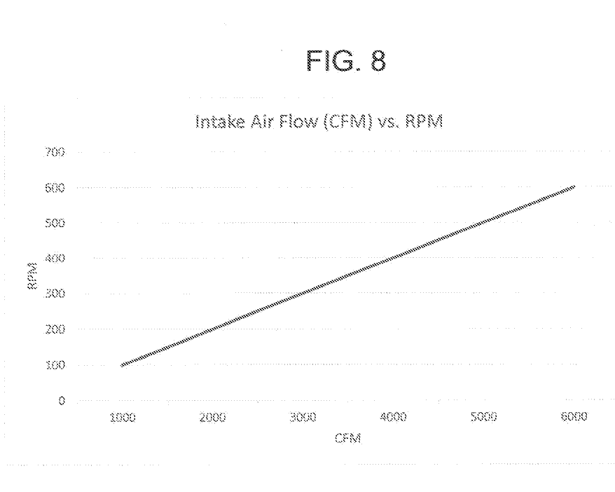

Another embodiment of the invention is reliant on the combination of CPS 4, or substitute rotating sensor, and MAF (mass air sensor) 7. Referring to FIG. 8, an Illustration of the nature of intake air quantity as measured in CFM in relation to engine RPM. FIG. 8 depicts a typical 300 Horsepower spark ignited internal combustion engine with a VE (volumetric efficiency) of about 85%. Generally spark ignited engines require a volume of intake air that increases at a linear rate with increasing RPM. Intake air is measured by MAF 7 that produces and electronic signal outputted through output connection 17. In all cases, and under proper operation the MAF 7 if there is no intake, indicating the engine is not running, or if it is operating, then the quantity of air passing through MAF is directly correlated to the actual Horsepower that an internal combustion spark ignited, or compression ignited engine is actually producing.

It should be noted that each engine family is calibrated at time of manufacturer such that a particular MAF 7 produces a known signal value that directly correlates to that actual engine's produced Horsepower, and at any given RPM. However, the correlation to actual horsepower produced is predicated on optimal and proper ignition timing and advance and the correct air fuel ratio, and in the case of compression ignited engines, the proper air fuel ratio.

In this embodiment, there are predetermined relationships of timing retard, through the delay in CPS 4 signal pulses provided to the ECU 21, and a reduction in the signal values of the MAF 7 as they are also provided to the ECU 21, via the ECP 8. For minor reductions in engine power with this inventive engine sensor signal manipulating system, either the values of MAF 7 can be reduced or CPS 4 signal pulses can be delayed.

Independently, if the signal values of MAF 7 are only reduced, with further reduction the combustion mixture will become considerably lean, and engine damage and harmful tailpipe discharge will occur. Alternatively, if just the signal pulses of CPS 4 are delayed or retarded, with further reduction, the combustion mixture will become considerably rich and fuel will cause spark plugs to miss-fire, and excessive fuel may dilute the cylinder walls, prematurely wearing the piston rings and excessive un-burned hydrocarbons and other harmful tailpipe discharge will be emitted.

Thus in some aspects of operation, either MAF 7 or CPS 4 signals could be conditioned exclusively by ECP 8 for minor power reduction events. But when more significant engine 5 power reduction is needed, both of these sensor outputs in communication with the invention allow the engine timing to be reduced and the rich air fuel ratio that is the result to be modulated and equalized by the reduction of engine fuel supply as in operation of this invention in communication with MAF 7.

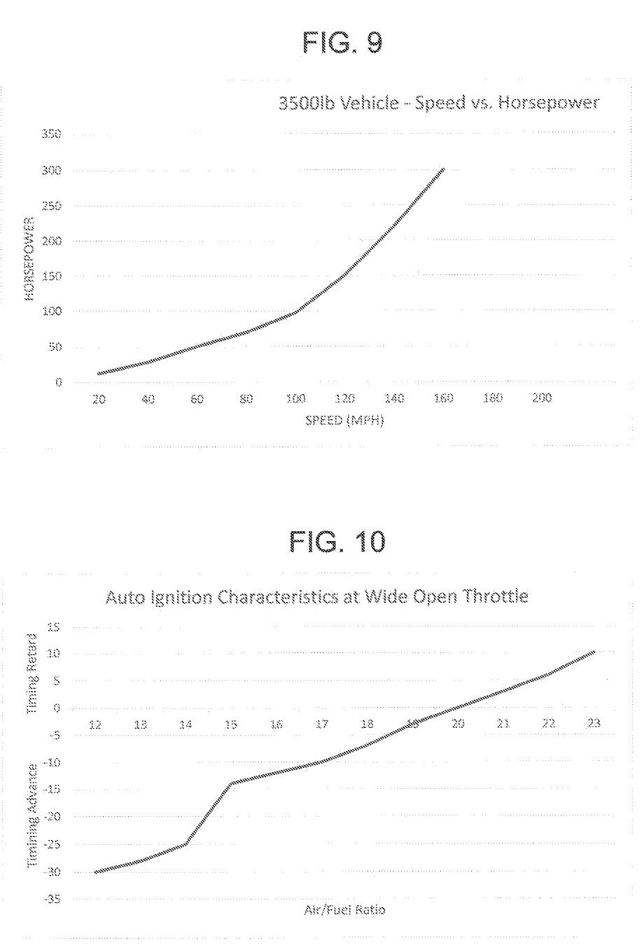

Turning to FIG. 9, is a line graph of the relationship of engine horsepower powering a typical 3500 pound vehicle and its potential top speed. As FIG. 9 indicates, it requires exponentially more horsepower to reach higher vehicle speeds. This line graph emphases, alternatively just how little horsepower that it can require to reach potentially deadly speeds, in the event that in intoxicated driver is allowed to continue to drive, as is the proper operation or BAIIDS on the roads today. FIG. 9 strongly illustrates that only a small percentage of available horsepower will allow a vehicle to maintain highway speeds.

As importantly, is should be understood that for power reduction of a vehicle engine is required as an intoxicated driver is attempting to operate a vehicle, the level of power reduction, in order to effectively minimize vehicle speed, may easily be more that 90% power reduction. For low horsepower equipped vehicles, a lesser amount would be effective and for high horsepower performance vehicles, power reduction of more than 95% would sometimes be the only effective way to maintain public safety on the roads.

My invention, and with its multiple benefits, attributes and significant adaptability very effectively blocks an engine from starting when needed and reduces engine power to whatever desired extent is deemed reasonable to reduce speed related accidents caused by intoxicated drivers. As importantly, it does this within the current scope of knowledge and skills of the staff and within the capabilities of facilities that currently install and monitor BAIIDS.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. An apparatus for the control of vehicle engine operation, as determined by the driver's blood alcohol concentration comprising;
at least one electronic sensor that monitors an operational condition of said engine; and
a processor that receives a signal from the at least one sensor, said processor programmed to modify the signal from the at least one sensor; and
a driver breath alcohol measurement system to provide driver blood alcohol content to the said processor; and
an ECU to receive at least one electronic signal from a sensor equipped engine to control operation of said engine;
wherein said processor is in communication with said ECU so as to reduce said engine's power and ability to start.

2. The apparatus of claim 1, comprising; a modified electronic signal to the ECU such that said ECU retards engine ignition timing.

3. The apparatus of claim 1, comprising; a modified electronic signal to the ECU that reduces the quantity of fuel supplied by the fuel injectors.

4. The apparatus of claim 1, comprising; a signal that monitors the rotation of said engine, wherein the processor modifies this electronic signal to the ECU, wherein said ECU provides no ignition energy to spark plugs, such that said engine will not start.

5. The apparatus of claim 1, comprising; a signal that monitors the rotation of said engine, wherein the processor modifies this electronic signal to the ECU such that said engine power is reduced.

6. The apparatus of claim 1, comprising; A modified signal generated from the ECP that momentarily reduces power at least one time, or in a series of engine power reduction events, such that driver experiences a short vehicle braking sensation.

7. The apparatus of claim 1, comprising; modified electronic signals from the MAF and CPS sensors generated by the ECP, such that the vehicle engine is unable to start.

8. The apparatus of claim 1, comprising; modified electronic signals from the MAF and CPS sensors generated by the ECP, such that the vehicle engine power output is reduced.

9. The apparatus of claim 1, comprising; a modified electronic signal from the CPS, such that the vehicle engine is unable to start.

10. The apparatus of claim 1, comprising; a modified and interrupted signal from the CPS, such that the vehicle engine power output is reduced.

11. The apparatus of claim 1, comprising; a pre-configured series of wiring harness sections that directly plug in line, into male or female connections of the at least one sensor, the ECP and the ECU.

12. An apparatus for the control vehicle engine operation, as determined by the driver's blood alcohol concentration comprising;
a vehicle with at least one electronic sensor that monitors the rotation of said engine; and
a processor that receives a signal from the at least one sensor, said processor is programmed to modify the signal from the at least one sensor; and
a driver breath alcohol measurement system to provide driver blood alcohol content to the said processor; and
an ECU to receive at least one electronic signal from a sensor equipped engine to control operation of said engine;
wherein said processor is in communication with the said ECU so as to reduce said engine's power and ability to start.

13. The apparatus of claim 12, comprising; a modified electronic signal to the ECU such that said ECU retards engine ignition timing.

14. The apparatus of claim 12, comprising; a modified electronic signal to the ECU such that said ECU reduces the quantity of fuel supplied by the fuel injectors.

15. The apparatus of claim 12, comprising; an engine sensor signal that monitors the operation of said engine, wherein the processor modifies this electronic signal to the ECU wherein said ECU provides no ignition energy to spark plugs, such that said engine will not start.

16. The apparatus of claim 12, comprising; an engine sensor signal that calculates intake air quantity of said engine, wherein the processor modifies this electronic signal to the ECU such that said engine power is reduced.

17. The apparatus of claim 12, comprising; A modified signal generated from the ECP that momentarily reduces power at least one time, or in a series of engine power reduction events, such that driver experiences a short vehicle braking sensation.

18. The apparatus of claim 12, comprising; modified electronic signals from the MAF and CPS sensors generated by the ECP, such that the vehicle engine is unable to start.

19. The apparatus of claim 12, comprising; modified electronic signals from the MAF and CPS sensors generated by the ECP, such that the vehicle engine power output is reduced.

20. The apparatus of claim 12, comprising; a modified electronic signal from the CPS, such that the vehicle engine is unable to start.

21. The apparatus of claim 12, comprising; a modified and interrupted signal from the CPS, such that the vehicle engine power output is reduced.

22. The apparatus of claim 12, comprising; a pre-configured series of wiring harness sections that directly plug in line, into male or female connections of the at least one sensor, the ECP and the ECU.

23. A method of reducing available vehicle engine power, comprising the steps of determining that driver blood alcohol content is above a pre-determined threshold and modifying the electronic output of at least one engine sensor to the ECU, such that said ECU limits available engine power.

24. The method of claim 23, comprising the step of retarding the engine's ignition timing.

25. The method of claim of 23, comprising the step of reducing the quantity of fuel supplied by the fuel injectors.

26. The method of claim 23, comprising the steps of retarding ignition timing and fuel supply simultaneously so as to reduce engine power.

27. The method of claim 23, comprising the steps of repeatedly interrupting the CPS electronic signal to reduce engine power.

28. A method of blocking an engine's ability to start, comprising the steps of determining that driver blood alcohol content is above a pre-determined threshold and modifying the electronic output of at least one engine sensor to the ECU, such that said ECU will not allow the engine to start.

29. The method of claim 28, comprising the step of eliminating any electronic current to the spark plugs.

30. The method of claim 28, comprising the step of blocking the CPS electronic signal.
